(19) United States
(12) Patent Application Publication
(10) Pub. No.: US 2026/0189866 A1
(43) Pub. Date: Jul. 2, 2026

(54) AUDIO DEVICE WITH MICROPHONE ARM ORIENTATION DETECTOR

(71) Applicant: GN Hearing A/S, Ballerup (DK)

(72) Inventor: Lars Ivar HAUSCHULTZ, Ballerup (DK)

(21) Appl. No.: 19/433,401

(22) Filed: Dec. 26, 2025

(30) Foreign Application Priority Data
Dec. 30, 2024 (EP) 24223628.9

(51) Int. Cl. H04R 29/00; H04R 1/08; H04R 1/10

(52) U.S. Cl. CPC H04R 29/004; H04R 1/08; H04R 1/1041

(57) ABSTRACT

The present invention relates to an audio device with a housing, a microphone arm and a detector for determining an orientation of the microphone arm relative to the housing. The invention may advantageously be applied in audio devices having a microphone arm, such as headsets, earphones, hearing protectors and other audio devices used for sound pickup.

The audio device comprises a housing, a microphone arm that is mechanically and movably connected to the housing, a microphone unit arranged at or in the microphone arm and configured to pick up sound from the environment of the audio device and provide a corresponding microphone audio signal, a signal processor arranged at or in the housing and configured to provide electric power to the microphone unit, and a flexible substrate extending in a length direction between a first end mechanically connected to the housing and a second opposite end mechanically connected to the microphone arm.

The flexible substrate is configured to bend in dependence on the microphone arm moving relative to the housing and comprises one or more electrical conductors electrically connecting the microphone unit and the signal processor to convey the electric power from the signal processor to the microphone unit and/or the microphone audio signal from the microphone unit to the signal processor.

The flexible substrate further comprises a bend sensor that is configured to change the value of an electric property in dependence on a bending of a first portion of the flexible substrate, and the audio device further comprises a bend detector electrically connected to the bend sensor and configured to estimate an orientation of the microphone arm relative to the housing in dependence on the value of the electric property of the bend sensor.

Arranging the bend sensor at or in the flexible substrate may provide a both reliable and cost-effective estimation of the orientation of the microphone arm.

### TECHNICAL FIELD

The present invention relates to an audio device with a housing, a microphone arm and a detector for determining an orientation of the microphone arm relative to the housing. The invention may advantageously be applied in audio devices having a microphone arm, such as headsets, earphones, hearing protectors and other audio devices used for sound pickup.

### BACKGROUND ART

It is known to equip a headset with a rotatable microphone arm to enable a user of the headset to change the orientation of the microphone arm relative to the headset, e.g. for optimizing pickup of the user's own voice sound. It is also known to equip such a headset with means for determining this orientation to enable, for instance, muting of a microphone in the microphone arm when the orientation of the microphone arm has attained an orientation within a predefined range of orientations relative to the headset.

For instance, EP 2178275 B1 discloses a headset with a 360 degrees rotatable microphone boom. Electric power and electronic signals are commuted between the microphone boom and the housing part of the headset through a set of sliding contacts that slide on respective annular rings when the microphone boom is rotated. One or more of the annular rings may have regions that allow the electrical connection across the sliding contact to be either short-circuited or broken when the microphone boom is oriented in specific directions, e.g. to provide a mechanical muting function.

It is also known to provide electrical connections between a circuitry and a microphone that is movable relative to the circuitry through a flexible circuit board (FCB) element.

For instance, U.S. Pat. No. 7,032,728 B2 discloses a retractable cable assembly, in which a retractable cable for a microphone is electrically connected to one end of an FCB element comprising a coiled strip of FCB so that the coil of FCB can wind and unwind as the cable is used. The FCB element may include a length of FCB and a land portion of FCB from which the length portion extends. The land portion may provide a means for connecting with suitable circuitry, such as input circuitry. The cable assembly may include a sensor/trigger means, e.g. a microswitch or a photocell, which may be activated when the cable is unwound and/or retracted to provide a signal of this and to allow a suitable corresponding action to occur. For example, in the case of a mobile telephone or portable computing device, the extension of the cable could switch the sound output of the telephone or computer from a standard speaker of the telephone or computer to an earpiece output.

The prior art leaves space for improvements.

### DISCLOSURE OF INVENTION

It is an object of the present invention to provide an improved audio device with a housing, a microphone arm that is rotatable with respect to the housing, and a detector for determining an orientation of the microphone arm relative to the housing.

This and other objects of the invention are achieved by the invention defined in the independent claims and further explained in the following description. Further objects of the invention are achieved by embodiments defined in the dependent claims and in the detailed description of the invention.

### BRIEF DESCRIPTION OF THE DRAWINGS

The invention will be explained in more detail below in connection with preferred embodiments and with reference to the drawings in which:

FIG. 1 shows a first embodiment of an audio device according to the invention,

FIG. 2 shows details of the embodiment of FIG. 1,

FIG. 3 shows further details of the embodiment of FIG. 1, and

FIG. 4 shows a second embodiment of an audio device according to the invention.

The figures are schematic and simplified for clarity, and they just show details essential to understanding the invention, while other details may be left out. Where practical, like reference numerals and/or names are used for identical or corresponding parts.

### MODE(S) FOR CARRYING OUT THE INVENTION

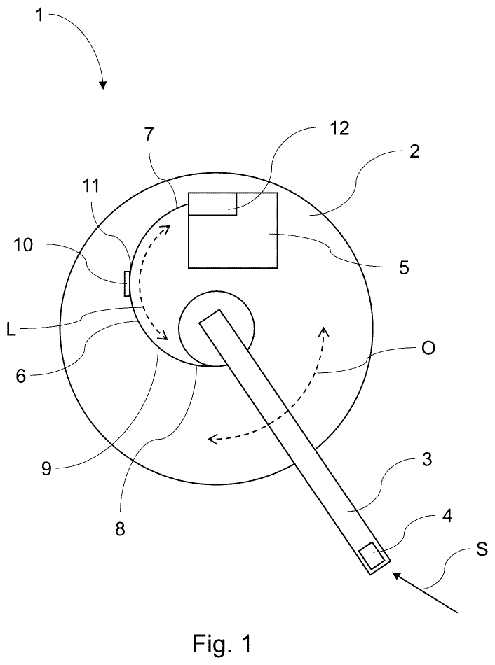

FIG. 1 shows an audio device 1 with a housing 2, a microphone arm 3, a microphone unit 4, a signal processor 5, and a flexible substrate 6.

The microphone arm 3 is mechanically and movably connected to the housing 2. In some embodiments, the microphone arm 3 may be slidably connected to the housing 2. In some embodiments, the microphone arm 3 may be rotatably connected to the housing 2. In some embodiments, the microphone arm 3 may be slidably and rotatably connected to the housing 2. The microphone arm 3 may, e.g., be pivotable around a rotary joint (not shown) mechanically connecting the microphone arm 3 with the housing 2.

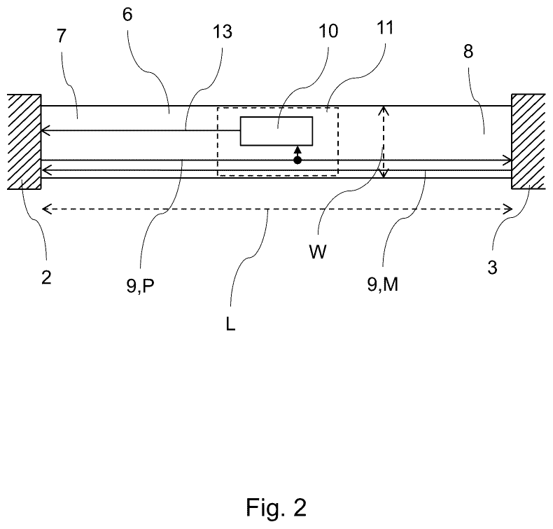

The microphone unit 4 is arranged at or in the microphone arm 3, preferably away from the housing 2, and configured to pick up sound S from the environment of the audio device 1 and provide a corresponding microphone audio signal M (see FIG. 2).

The signal processor 5 is arranged at or in the housing 2 and configured to provide electric power P (see FIG. 2) to the microphone unit 4.

The flexible substrate 6 extends in a length direction L between a first end 7 that is mechanically connected to the housing 2 and a second opposite end 8 that is mechanically connected to the microphone arm 3.

The flexible substrate 6 is configured to bend in dependence on the microphone arm 3 moving relative to the housing 2 and comprises one or more electrical conductors 9 electrically connecting the microphone unit 4 and the signal processor 5 to convey the electric power P from the signal processor 5 to the microphone unit 4 and/or the microphone audio signal M from the microphone unit 4 to the signal processor 5.

The flexible substrate 6 further comprises a bend sensor 10 that is configured to change the value of an electric property in dependence on a bending of a first portion 11 of the flexible substrate 6. The bend sensor 10 may preferably be mechanically connected to the surface of, or embedded within, the flexible substrate 6, such that the mechanical connection between the bend sensor 10 and the flexible substrate 6 extends in the length direction L of the flexible substrate 6.

The audio device 1 further comprises a bend detector 12 electrically connected to the bend sensor 10 and configured to estimate an orientation O of the microphone arm 3 relative to the housing 2 in dependence on the value of the electric property of the bend sensor 10. The bend detector 12 may preferably be electrically connected to the bend sensor 10 through the one or more electrical conductors 9 electrically connecting the microphone unit 4 and the signal processor 5 to convey the electric power P from the signal processor 5 to the microphone unit 4 and/or the microphone audio signal M from the microphone unit 4 to the signal processor 5. In some embodiments, the bend detector 12 may provide the estimated orientation O of the microphone arm 3 to the signal processor 5. In some embodiments, the bend detector 12 may be comprised by the signal processor 5. In some embodiments, the signal processor 5 may be configured to process the microphone audio signal M in dependence on the orientation O of the microphone arm 3 estimated by the bend detector 12.

FIG. 2 shows the flexible substrate 6 in a stretched state and viewed from the side where the bend sensor 10 is arranged in FIG. 1. The arrow W indicates a width direction of the flexible substrate 6.

The flexible substrate 6 extends in its length direction L between the housing 2 at its first end 7 and the microphone arm 3 at its second end 8. FIG. 2 also shows electrical conductors 9 electrically connecting the microphone unit 4 and the signal processor 5 to convey respectively the electric power P from the signal processor 5 in the housing 2 to the microphone unit 4 in the microphone arm 3 and the microphone audio signal M from the microphone unit 4 to the signal processor 5. The bend sensor 10 is arranged at half distance between the first end 7 and the second end 8 of the flexible substrate 6, so that it can change the value of an electric property in dependence on a bending of the middle portion 11 of the flexible substrate 6.

As also shown in FIG. 2, the bend sensor 10 may receive power P from the signal processor 5 through the electrical conductors 9 electrically connecting the microphone unit 4 and the signal processor 5 to convey the electric power P to the microphone unit 4, and the bend detector 12 may receive an output signal indicating the value of the electric property of the bend sensor 10 through one or more electrical conductors 13 dedicated for that purpose. This may help reducing the number of electrical conductors to route via the flexible substrate 6. Alternatively, the bend detector 12 may be electrically connected to the bend sensor 10 and/or the signal processor 5 only through such dedicated electrical conductors 13.

Depending on the configuration of the audio device 1, the flexible substrate 6 may be subject to the largest bending forces at its ends 7, 8. Accordingly, the end portions of the flexible substrate 6 may be better candidates for selecting the first portion 11 to maximize the sensitivity of the output signal of the bend sensor 10. Correspondingly, the bend sensor 10 may alternatively be arranged at or near the first end 7 of the flexible substrate 6 or at or near the second end 8 of the flexible substrate 6. This may help improving the reliability and/or the accuracy of the estimated orientation O.

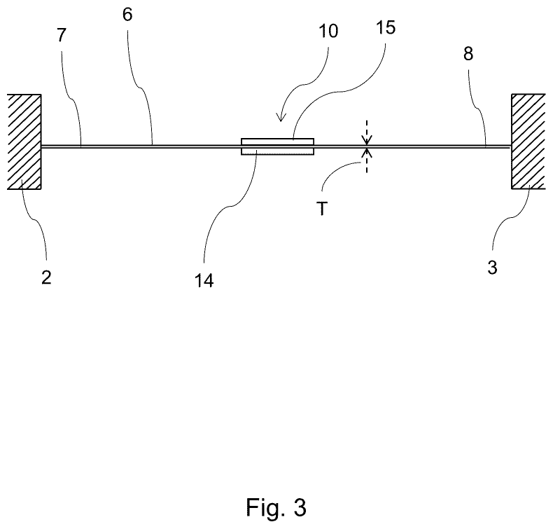

FIG. 3 shows the flexible substrate 6 in the stretched state and viewed from the same side as in FIG. 1. The arrow T indicates a thickness direction of the flexible substrate 6.

The bend sensor 10 comprises a first sensor component 14 arranged on a first side of the flexible substrate 6 and a second sensor component 15 arranged on the opposite second side of the flexible substrate 6 and configured such that the value of an electric property of the first sensor component 14 changes in the opposite direction of the value of an electric property of the second sensor component 15 when the flexible substrate 6 changes its bend. The bend sensor 10 is configured such that the value of the electric property of the bend sensor 10 depends on the values of the electric properties of the first sensor component 14 and the second sensor component 15. Alternatively, the bend sensor 10 may comprise only the first sensor component 14.

The electric property of the bend sensor 10 may comprise an electric impedance, such as one or more electric resistances. The first sensor component 14 and/or the second sensor component 15 may each comprise a resistor component that changes its resistance value when subjected to strain in the form of compression or expansion in the length direction of the flexible substrate 6, such as an appropriately arranged resistance-based strain gauge.

Alternatively, or additionally, the electric property of the bend sensor 10 may comprise one or more electric capacitances. The first sensor component 14 and/or the second sensor component 15 may each comprise a capacitor component that changes its capacitance value when subjected to strain in the form of compression or expansion in the length direction of the flexible substrate 6, such as an appropriately arranged capacitance-based strain gauge, such as, e.g., two or more interdigitated capacitive electrodes.

In embodiments with only a single sensor component 14, 15, the bend detector 12 may estimate the orientation O of the microphone arm 3 by measuring the resistance and/or capacitance of the sensor component 14, 15. In embodiments with two or more sensor components 14, 15, the bend detector 12 may estimate the orientation O of the microphone arm 3 by measuring and comparing the resistances and/or capacitances of the sensor components 14, 15. Alternatively, the two or more sensor components 14, 15 may be electrically connected in series to form a voltage divider, and the bend detector 12 may estimate the orientation O of the microphone arm 3 by measuring an output voltage of the voltage divider and/or comparing the output voltage with one or more predefined voltage thresholds.

The sensor components 14, 15 may preferably be formed on the flexible substrate 6 in the same process that forms electrical conductors 9, 13 on the surface of the flexible substrate 6. Alternatively, the sensor components 14, 15 may be depleted, printed, glued, or otherwise mechanically attached onto the surface of the flexible substrate 6. In some embodiments, the sensor components 14, 15 may be embedded within the flexible substrate 6, e.g., by applying a further substrate layer on top of the depleted, printed, glued, or otherwise mechanically attached sensor components 14, 15.

Generally, the length of the flexible substrate 6, when stretched, should be much larger than any extension of the flexible substrate 6 in directions W, T perpendicular to the length direction L, such as by a factor of at least 3, at least 5, or at least 10. This may help enable large movement or rotation of the microphone arm 3 without requiring an increase in the size of the housing 2.

Also generally, the thickness of the first portion 11 of the flexible substrate 6, or of the entire flexible substrate 6, should be relatively small, such as less than 1 mm, less than 0.5 mm, less than 0.3 mm, less than 0.2 mm, or less than 0.1 mm. This may help enable large movement or rotation of the microphone arm 3 without risking damage to the flexible substrate 6 or any attached sensor components 14, 15.

In some embodiments, the flexible substrate 6 may comprise two or more bend sensors 10 each configured to change the value of an electric property in dependence on a bending of a respective first portion 11 of the flexible substrate 6. In some embodiments, the bend detector 12 may be electrically connected to each of the two or more bend sensors 10 and configured to estimate an orientation O of the microphone arm 3 relative to the housing 2 in dependence on the value of the electric property of the two or more bend sensors 10.

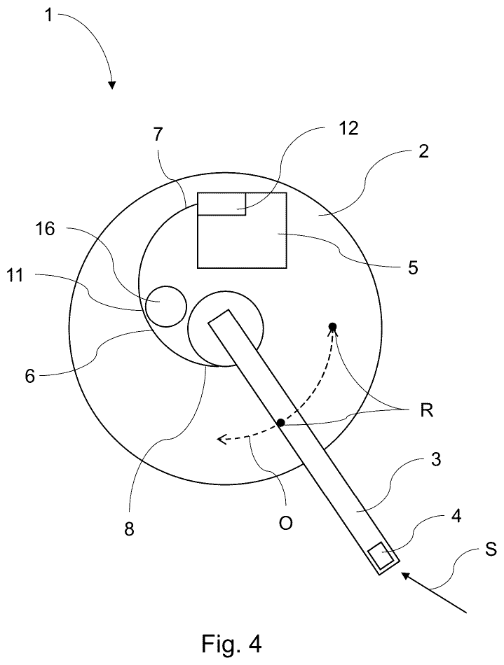

FIG. 4 shows an audio device 1 equal to the audio device 1 shown in FIG. 1, except for the housing 2 being configured such that the first portion 11 of the flexible substrate 6 abuts a portion 16 of the housing 2 when—and only when—the microphone arm 3 is within a predefined range of orientations O with respect to the housing 2. The limits of the predefined range are indicated by the two dots R. In this embodiment, a larger bending force may occur at or near the first portion 11 of the flexible substrate 6, and the bend sensor 10 may then preferably be arranged at or near such first portion 11 of the flexible substrate 6.

Generally, the housing 2 may be configured such that one or more first portions 11 of the flexible substrate 6 each abut a respective portion 16 of the housing 2 when—and only when—the microphone arm 3 is within a respective predefined range R of orientations O with respect to the housing 2, and one or more bend sensors 10 may preferably be arranged at or near such one or more first portions 11 of the flexible substrate 6.

The audio device 1 may be comprised by an earphone, a headset, a hearing protector, a speakerphone, a microphone device, or another audio device for picking up sound from the environment.

The signal processor 5 and/or the bend detector 12, and/or any portions hereof, may be implemented as analog circuits operating on analog signals or as digital circuits operating on digital signals. Where necessary, such circuits may comprise analog-to-digital and/or digital-to-analog converters. Functional blocks of digital circuits may be implemented in hardware, firmware or software, or any combination hereof. Digital circuits may perform the functions of multiple functional blocks in parallel and/or in interleaved sequence, and functional blocks may be distributed in any suitable way among multiple hardware units.

The detailed description given herein and the specific examples indicating preferred embodiments of the invention are intended to enable a person skilled in the art to practice the invention and should thus be seen mainly as an illustration of the invention. The person skilled in the art will be able to readily contemplate further applications of the present invention as well as advantageous changes and modifications from this description without deviating from the scope of the invention. Any such changes or modifications mentioned herein are meant to be non-limiting for the scope of the invention.

The invention is not limited to the embodiments disclosed herein, and the invention may be embodied in other ways within the subject-matter defined in the following claims. As an example, features of the described embodiments may be combined arbitrarily, e.g., to adapt the devices according to the invention to specific requirements.

Any reference numerals and names in the claims are intended to be non-limiting for their scope.

1. An audio device comprising;
a housing;
a microphone arm that is mechanically and movably connected to the housing;
a microphone unit arranged at or in the microphone arm and configured to pick up sound from the environment of the audio device and provide a corresponding microphone audio signal;
a signal processor arranged at or in the housing and configured to provide electric power to the microphone unit; and
a flexible substrate extending in a length direction between a first end mechanically connected to the housing and a second opposite end mechanically connected to the microphone arm, wherein the flexible substrate is configured to bend in dependence on the microphone arm moving relative to the housing and comprises one or more electrical conductors electrically connecting the microphone unit and the signal processor to convey the electric power from the signal processor to the microphone unit and/or the microphone audio signal from the microphone unit to the signal processor,
characterized in that:
the flexible substrate further comprises a bend sensor that is configured to change the value of an electric property in dependence on a bending of a first portion of the flexible substrate; and
the audio device further comprises a bend detector electrically connected to the bend sensor and configured to estimate an orientation of the microphone arm relative to the housing in dependence on the value of the electric property of the bend sensor.

2. Audio device according to claim 1, wherein the microphone arm is rotatably connected to the housing.

3. Audio device according to claim 1, wherein the bend sensor is mechanically connected to the surface of, or embedded within, the flexible substrate, such that the mechanical connection between the bend sensor and the flexible substrate extends in the length direction of the flexible substrate.

4. Audio device according to claim 1, wherein the bend detector is electrically connected to the bend sensor through the one or more electrical conductors electrically connecting the microphone unit and the signal processor to convey the electric power from the signal processor to the microphone unit and/or the microphone audio signal from the microphone unit to the signal processor.

5. Audio device according to claim 1, wherein the bend detector is comprised by the signal processor.

6. Audio device according to claim 1, wherein the bend sensor is arranged at or near the first end of the flexible substrate or at or near the second end of the flexible substrate.

7. Audio device according to claim 1, wherein the length of the flexible substrate, when stretched, is larger than any extension of the flexible substrate in directions perpendicular to the length direction by a factor of at least 3, at least 5, or at least 10.

8. Audio device according to claim 1, wherein the thickness of the first portion of the flexible substrate is less than 1 mm, less than 0.5 mm, less than 0.3 mm, less than 0.2 mm, or less than 0.1 mm.

9. Audio device according to claim 1, wherein the bend sensor comprises a first sensor component arranged on a first side of the flexible substrate and a second sensor component arranged on the opposite second side of the flexible substrate, such that the value of an electric property of the first sensor component changes in the opposite direction of the value of an electric property of the second sensor component when the flexible substrate changes its bend, and wherein the value of the electric property of the bend sensor depends on the value of the electric properties of the first sensor component and the second sensor component.

10. Audio device according to claim 1, wherein the electric property of the bend sensor comprises one or more electric resistances.

11. Audio device according to claim 1, wherein the electric property of the bend sensor comprises one or more electric capacitances.

12. Audio device according to claim 11, wherein the bend sensor comprises two or more interdigitated capacitive electrodes.

13. Audio device according to claim 1, wherein the signal processor is configured to process the microphone audio signal in dependence on the orientation of the microphone arm estimated by the bend detector.

14. An earphone comprising an audio device according to claim 1.
